(19) United States
(12) Patent Application Publication
(10) Pub. No.: US 2024/0414666 A1
(43) Pub. Date: Dec. 12, 2024

(54) PHYSICAL LAYER SECURE COMMUNICATION

(71) Applicant: QUALCOMM Incorporated, San Diego, CA (US)

(72) Inventors: Ahmed ELSHAFIE, San Diego, CA (US); Alexandros MANOLAKOS, Athens (GR); Hung Dinh LY, San Diego, CA (US)

(21) Appl. No.: 18/694,940

(22) PCT Filed: Sep. 2, 2022
(86) PCT No.: PCT/US2022/042513

§ 371 Date: Mar. 22, 2024

(30) Foreign Application Priority Data
Nov. 19, 2021 (GR) 20210100811

(51) Int. Cl. H04W 56/00; H04B 7/06; H04L 5/00; H04W 12/043

(52) U.S. Cl. CPC H04W 56/0015; H04B 7/06968; H04L 5/0051; H04W 12/043

(57) ABSTRACT

A network node may transmit an SSB indicating that the network may support physical layer security, and a UE may extract the secret key for the physical layer security based on the received SSB indicating that the network may support the physical layer security. The network node may indicate a level of the physical layer security using the SSB, and the UE may determine the level of the physical layer security based on the received SSB. In one aspect, the indication that the network may support the physical layer security may be included in the SSB. In another aspect, a synchronization raster of the SSB may indicate that the network supports the physical layer security.

### CROSS REFERENCE TO RELATED APPLICATION

This application claims the benefit of and priority to Greek Patent Application Serial No. 20210100811, entitled “PHYSICAL LAYER SECURE COMMUNICATION” and filed on Nov. 19, 2021, which is expressly incorporated by reference herein in its entirety.

### TECHNICAL FIELD

The present disclosure relates generally to communication systems, and more particularly, to wireless communication including a secret key for providing a physical security.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a user equipment configured to receive, from a base station, an SSB that indicates a network supports physical layer security, extract a secret key for the physical layer security with the network in response to the SSB indicating that the network supports the physical layer security, and transmit or receive communication with the base station using the secret key.

In an aspect of the disclosure, a method, a computer-readable medium, and an apparatus are provided. The apparatus may include a network node configured to transmit an SSB that indicates a network supports physical layer security, extract a secret key based on a reference signal received from a UE, and transmit or receive communication using the secret key.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A illustrates an example of wireless communication, in accordance with various aspects of the present disclosure.

FIG. 4B is a diagram illustrating a first example of a wireless communication system, in accordance with various aspects of the present disclosure.

FIG. 5A is a diagram illustrating a base station in communication with a UE, in accordance with various aspects of the present disclosure.

FIG. 5B illustrates an example SSB of wireless communication, in accordance with various aspects of the present disclosure.

FIGS. 6A and 6B illustrate example SSB patterns, e.g., for transmission using FR2.

FIG. 7 illustrates an example of beam-sweeping, in accordance with various aspects of the present disclosure.

FIG. 8A illustrates an example raster grids for indicating the physical layer security.

FIGS. 8B and 8C illustrate example aspects of SSBs associated with network support for physical layer security.

FIG. 9 is a call-flow diagram of a method of wireless communication, in accordance with various aspects of the present disclosure.

FIG. 10 is a flowchart of a method of wireless communication.

FIG. 11 is a flowchart of a method of wireless communication.

FIG. 12 is a flowchart of a method of wireless communication.

FIG. 13 is a flowchart of a method of wireless communication.

FIG. 14 is a diagram illustrating an example of a hardware implementation for an example apparatus and/or network entity.

FIG. 15 is a diagram illustrating an example of a hardware implementation for an example network entity.

FIG. 16 is a diagram illustrating an example of a hardware implementation for an example network entity.

### DETAILED DESCRIPTION

Secure communication mechanisms may be used in wireless communications systems to protect information from suffer security breaches due to eavesdropping devices. In some aspects, wireless communication may provide a higher-layer security scheme. The UE and the network node may be configured with a set of secure rasters to share or configure a secret key for physical layer security. The secret key may be extracted or shared through the secure raster.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically crasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (CNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

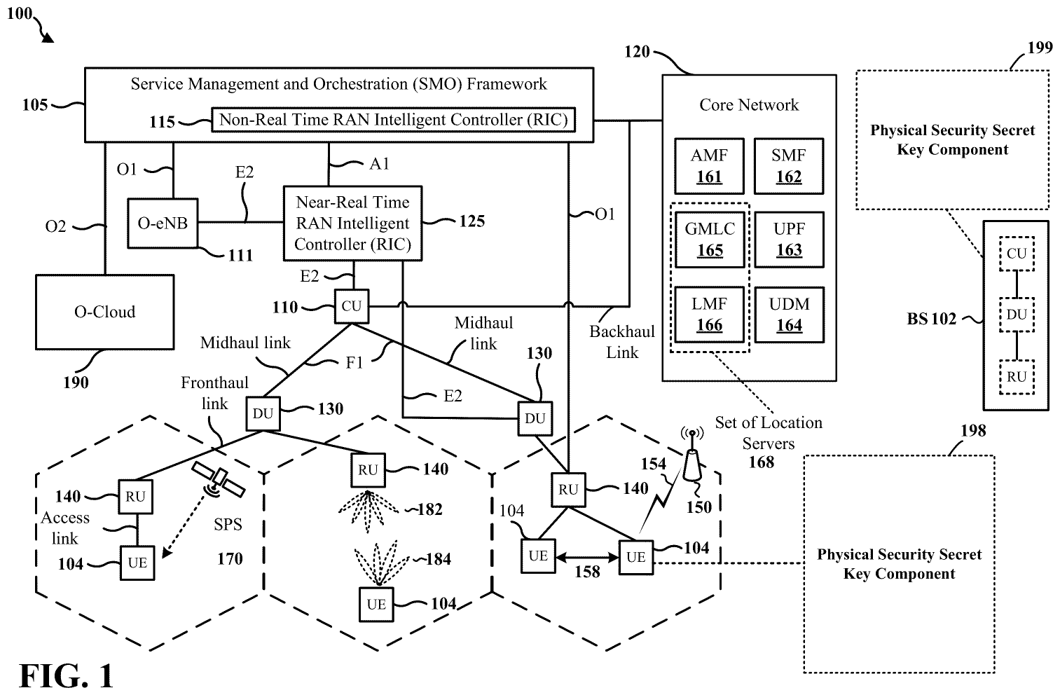

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-cNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHZ). Although a portion of FR1 is greater than 6 GHZ, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHZ-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a physical security secret key component 198 configured to receive, from a base station, an SSB that indicates a network supports physical layer security, extract a secret key for the physical layer security with the network in response to the SSB indicating that the network supports the physical layer security, and transmit or receive communication with the base station using the secret key. In certain aspects, the base station 102 may include a physical security secret key component 199 configured to transmit an SSB that indicates a network supports physical layer security, extract a secret key based on a reference signal received from a UE, and transmit or receive communication using the secret key. Although the following description may be focused on 5G NR, the concepts described herein may be applicable to other similar areas, such as LTE, LTE-A, CDMA, GSM, and other wireless technologies.

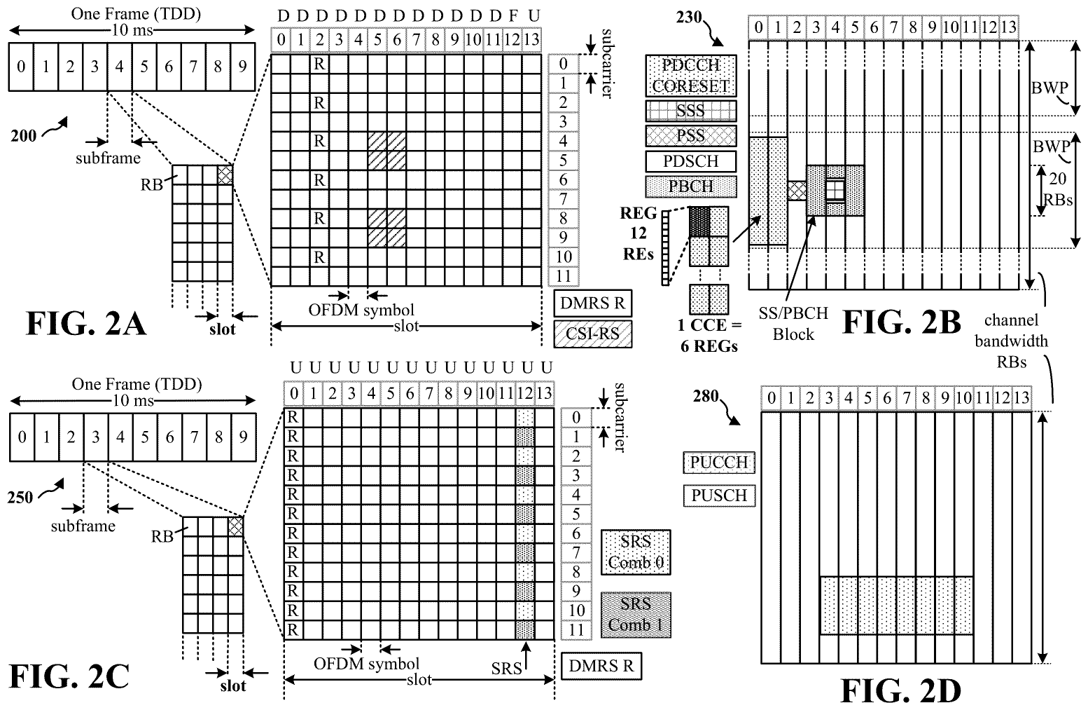

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

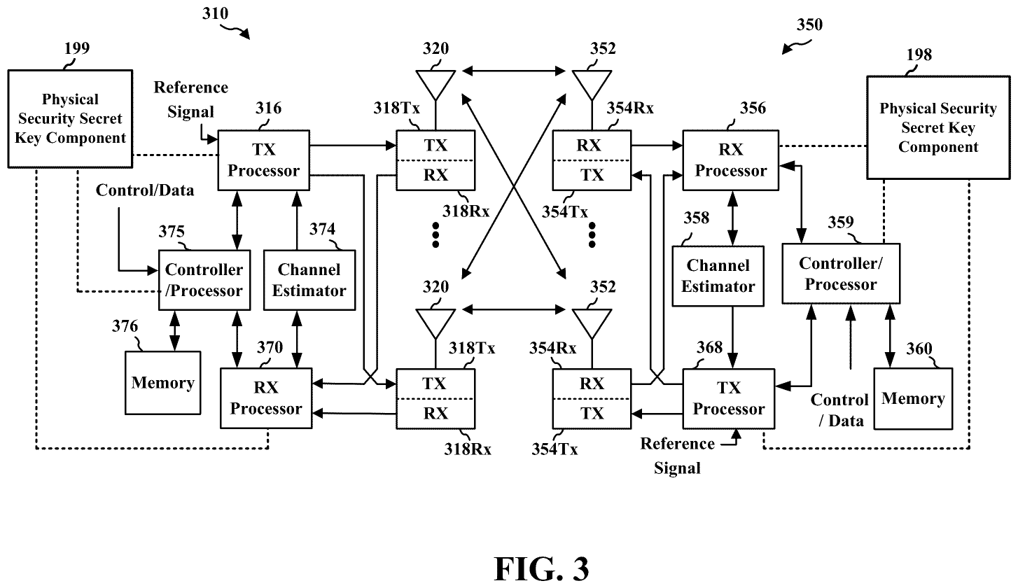

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the physical security secret key component 198 of FIG. 1. At least one of the TX processor 316, the RX processor 370, and the controller/processor 375 may be configured to perform aspects in connection with the physical security secret key component 199 of FIG. 1.

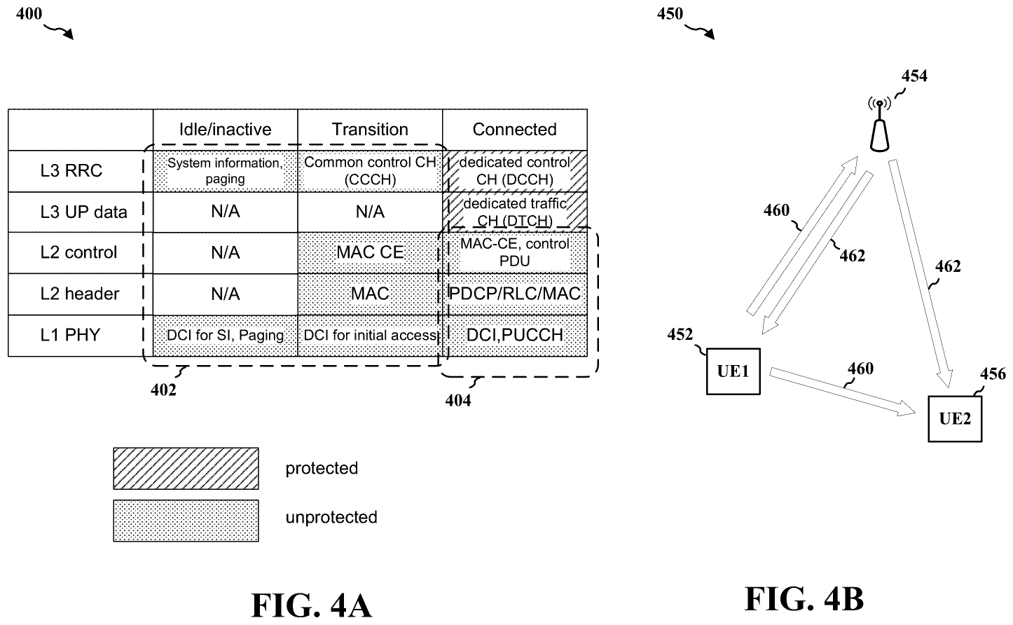

FIG. 4A illustrates an example 400 of layers of wireless communication and examples of potential security for different RRC connection states. For example, the protected channels and/or signals may be different for different layers and depending on the RRC status of the UE. In one aspect, a dedicated control channel (DCCH) on an L3 RRC layer and a dedicated traffic channel (DTCH) on an L3 UP data channel for the UE in the connected state may be protected by the higher layer security scheme. Accordingly, a first set of signals and/or channels 402 for the UE in the idle/inactive state or a transition state between the idle/inactive state and the connected state may not be protected, and a second set of signals and/or channels 404 on the lower layer for the UE in the connected state may not be protected. As one example, the UE may be connected to a fake network node, e.g., a network node or a base station that is not a legitimate network node or a legitimate base station of a wireless network. In other aspects, another type of eavesdropping device may access the signaling between the UE and a legitimate network node. Security for the UE's signals and/or channels may help to protect the UE's information from being received by the fake network node or eavesdropper. In one aspect, the UE connected to the fake network node in the idle/inactive state or the transition status may cause an out-of-service notice on the first set of signals and/or channels 402. In another aspect, the UE connected to the fake network node in the connected status may cause throughput degradation in the second set of signals and/or channels 404.

IoT may include many devices connected to each other, and a higher level of security may further help to protect the information of individual UEs. In one aspect, the IoT devices may have a relatively low level of power, and the IoT devices may add more security with additional security bits obtained from channels and sounding signals between the nodes.

In some aspects, physical security may provide a higher level of security. The physical layer security may provide a secret-key sharing where a pair of devices (UEs) may try to extract a secret key from the channel and use them to secure some unsecured channels, e.g., PUCCH, DCI, etc., and further improve security of other channels, such as PDSCH, or PUSCH from physical security, respectively.

FIG. 4B is a diagram illustrating a first example 450 of a wireless communication system. The first example 450 may include a first UE 452 and a network node 454, and a second UE 456. Here, the first UE 452 and the network node 454 may communicate with each other, and the second UE 456 may be eavesdropping on the communication between the first UE 452 and the network node 454. That is, the first UE 452 may transmit a UL signal 460 to the network node 454, and the network node 454 may transmit a DL signal 462 to the first UE 452, and the second UE 456 may attempt to decode the UL signal 460 transmitted by the first UE 452 and/or the DL signal 462 transmitted by the network node 454. The first UE 452 and the network node 454 may provide a higher layer security scheme to prevent the second UE 456 from decoding the content of the communication signal based on the UL signal 460 or the DL signal 462.

The physical layer security scheme used in securing the data transmissions may be associated with a security level. The security level of the physical layer security may indicate the security strength of the physical layer security. In one aspect, the security level of the physical layer security scheme may include at least one of a low level, a medium level, or a high level; however, the aspects are not limited thereto, and the physical layer security scheme may include more than three levels. In another aspect, the security level of the physical layer security scheme may also include soft level security.

In one aspect, the security level may be based at least in part on the strength of the security techniques used in the physical layer security scheme to secure the data transmissions. That is, the strength of the security techniques used in the physical layer security scheme may affect the security level of the physical layer security scheme to secure the data transmissions.

In another aspect, the security level may be based at least in part on the type of security. For example, the type of security may include the physical security using the physical layer based on the secret key extraction, the physical security using upper layer secret key sharing methods, or a combination of thereof. Furthermore, within the type of the physical layer security, the type of physical channels may be taken into consideration.

In another aspect, the security level of the physical layer security scheme may be based at least in part on the types of the physical channels secured by the physical layer security scheme. For example, the types of the physical channels may include the DCI, the UCI, the PDSCH/PUSCH, the DCI and the UCI, or the DCI, the UCI, and the PDSCH. For example, the PDSCH or the PUSCH may be secured by L3 layer security, and the physical security may be additionally provided to the L3 layer security.

In another aspect, in a sidelink connection including a PC5 interface, the security level may be based at least in part on the security provided to the UEs on the sidelink or the types of the physical channels on the sidelink. In one example, the network node may configure the UE with a dedicated procedure or sidelink resources to provide the physical layer security. That is, the network node may configure sidelink reference signals for the sidelink layer secret key extraction or the network node may configure or have dedicated resources to share the secret keys or perform procedures to share the secret key either on the physical layer or the upper layers to obtain, share, or extract the secret keys. In another example, the types of the physical channels on the sidelink may include at least one of PSCCH, PSFCH, or SCI-2 carried on PSSCH (only data carried on PSSCH is L3 secured), or a combination thereof. In another aspect, the physical layer security is provided on the sidelink, the Uu interface, or the combination thereof.

In some aspects, a physical layer security scheme that depends on channel characteristics may be further provided to enhance the security of the control and data channels on the UL signal 460 and the DL signal 462, especially for those channels that are not covered by the higher-level security methods. For example, the first UE 452 and the network node 454 may extract a secret key for encrypting the data transmission between the first UE 452 and the network node 454. The second UE 456 may not be able to decode the data of the communication signal between the first UE 452 and the network node 454 without the secret key.

In some aspects, the secret key extraction may refer to extracting secret key from channel randomness. First, two devices, e.g., network node and UE, may send reference signals to each other. Each of the two devices may estimate the channel of the received reference signals and obtain certain metric based on the estimated channels, e.g., channel power, reference signal received power (RSRP), signal to interference and noise ratio (SINR), phase, etc. The two devices may quantize the mapped value and use the value as an input to a key derivation function, e.g., hash-based message authentication code (HMAC)-secure hash algorithm (SHA)-256 (HMAC-SHA-256), or a key generation function to obtain the secret key. The secret key may be obtained at both sides of the two devices. In one aspect, at high SNR cases the secret key may provide secure connection between the two devices without repetition of pilot signals or some key refinement procedure. The secret key may be used by the network node and the UE to secure transmissions and secure some fields within physical channels, e.g., certain information in PDCCH, PUCCH, PDSCH, PUSCH, etc.

As presented herein, new, e.g., different or separate, raster grids may be provided for secure communications. The new secure rasters may include SSB structure that may be same or different from regular rasters.

A raster may refer to a collection of frequency positions. A synchronization (sync) raster may indicate the frequency positions of the synchronization block that can be used by the UE for system acquisition when explicit signaling of the SSB position is not present. In some aspects, a global synchronization raster may be defined for all frequencies. The frequency position of the SSB may be defined as SSB reference frequency position (SSREF) with corresponding global synchronization channel number (GSCN). The parameters defining the SSREF and GSCN may be specified for at least some frequency ranges.

The network node may transmit the SSBs on multiple frequency locations, e.g., the sync raster. The sync raster may indicate the frequency positions of the SSB that can be used by the UE for system acquisition. That is, the sync raster may be associated with a set of center frequencies, and the network node may transmit the SSBs on multiple frequency locations, each frequency location of the multiple frequency locations being associated with one center frequency of the set of center frequencies. The UE may monitor the sync raster to receive the SSBs transmitted by the network node.

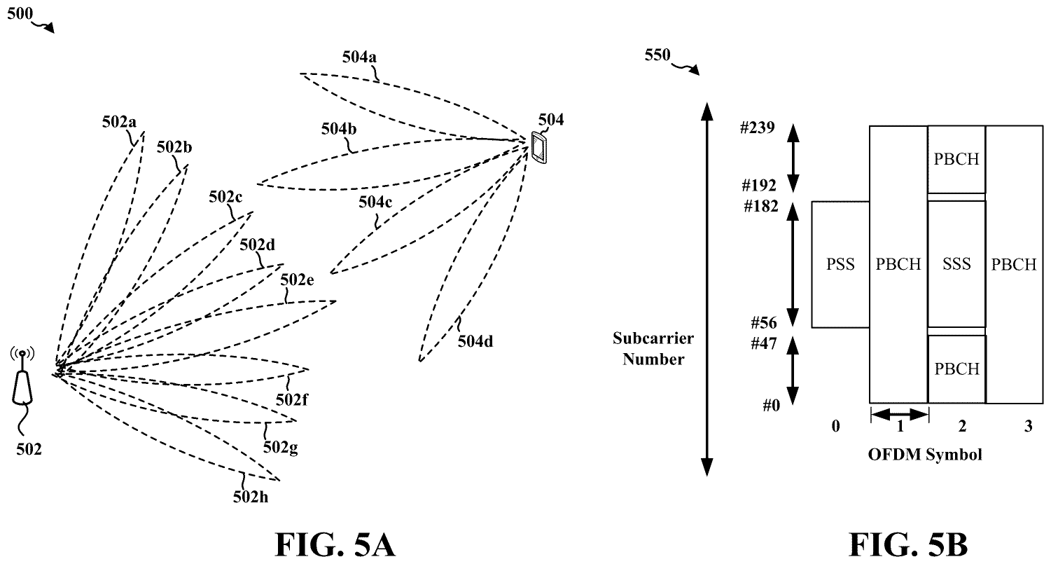

FIG. 5A is a diagram 500 illustrating a network node 502 in communication with a UE 504. Referring to FIG. 5A, the network node 502 may transmit a beamformed signal to the UE 504 in one or more of the directions 502a, 502b, 502c, 502d, 502e, 502f, 502g, 502h. The UE 504 may receive the beamformed signal from the network node 502 in one or more receive directions 504a, 504b, 504c, 504d. The UE 504 may also transmit a beamformed signal to the network node 502 in one or more of the directions 504a-504d. The network node 502 may receive the beamformed signal from the UE 504 in one or more of the receive directions 502a-502h. The network node 502/UE 504 may perform beam training to determine the best receive and transmit directions for each of the network node 502/UE 504. The transmit and receive directions for the network node 502 may or may not be the same. The transmit and receive directions for the UE 504 may or may not be the same. In some aspects, the beamformed signal transmitted by the network node 502 may include an SSB, such as described in connection with FIG. 2B.

In response to different conditions, such as a DCI for beam updating provided herein, the UE 504 may determine to switch beams, e.g., between beams 502a-502h or may determine that the network node will switch between beams. The beam at the UE 504 may be used for the reception of downlink communication and/or transmission of uplink communication. The beam at the network node 502 may be used for uplink reception and/or downlink transmission. In some examples, the network node 502 may send a transmission that triggers a beam switch by the UE 504.

In addition to a 120 kHz SCS used in some wireless communication systems, other SCS, such as 240 kHz, 580 kHz, and 960 kHz SCS may be used for wireless communication. In some aspects, a maximum bandwidth may be defined for wireless communication in a corresponding frequency range, e.g., for transmission/reception of data, control channels, and/or reference signals. In some aspects, a normal cyclic prefix (NCP) may be supported for the SCS. For example, in certain high frequency ranges, such as between 52.6 GHz and 71 GHz, a SCS of 240 kHz, 580 kHz, and/or 960 kHz may be used for SSB transmission by the network node 502, for initial access related signals/channels in an initial bandwidth part (BWP), and/or for SSB for non-initial access scenarios. In some aspects, the network node may transmit up to 64 SSB beams, e.g., using the licensed spectrum and/or the unlicensed spectrum in a frequency range, such as between 52.6 GHz and 71 GHz. In some aspects, a SCS of 240 kHz, 580 kHz, and/or 960 kHz may be used for SSB transmission and an additional SCS of a SCS of 580 kHz and/or 960 kHz may be used for signals and/or channels related to initial access in an initial BWP. In some aspects, a SCS of 580 kHz and/or 960 kHz may be used for SSB for wireless communication operations other than initial access. In some aspects, a common framework may be applied for 580 kHz and/or 960 kHz. Different PRACH sequence lengths such as L=139, L=571 and L=1151, may be additionally supported. The network node and UE may also support a configuration for non-consecutive ROs in a time domain for operation in a shared spectrum.

In some wireless communication systems, a network node may transmit an SSB that receiving UEs may use for an initial cell search. FIG. 5B illustrates an example SSB 550 of wireless communication. The SSB spans 5 OFDM symbols with 1 symbol for PSS, 2 symbols for PBCH, and 1 symbol with SSS and PBCH frequency domain multiplexed with each other. By way of example, in some wireless communication systems, an SCS of 15 kHz or 30 kHz may be used for FR1 and SCS of 120 kHz or 240 kHz may be used for FR2. The PSS may use a length of 127 frequency domain-based M-sequence (mapped to 127 subcarriers). For example, the PSS may have 3 possible sequences. The SSS may use a length of 127 frequency domain-based Gold Code sequence (2 M-sequences) (mapped to 127 subcarriers). By way of example there may be a total of 1008 possible sequences for the SSS. The PBCH may be QPSK modulated, and the UE may coherently demodulate the PBCH using an associated DM-RS from the network node.

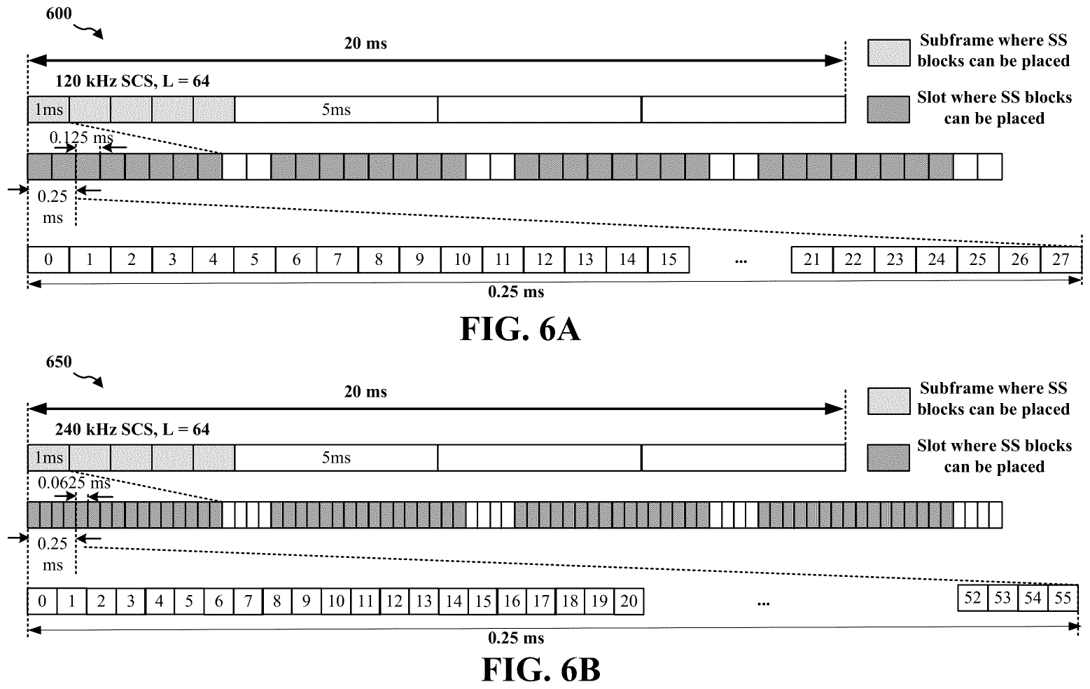

FIGS. 6A and 6B illustrate example SSB patterns, e.g., for transmission using FR2. As illustrated in example 600 of FIG. 6A, for 120 kHz SCS and PRACH sequence length L=64, within 20 ms, there may be twenty 1 ms subframes. Each 1 ms subframe may include forty 0.125 ms slots and each 0.25 ms period may include 28 OFDM symbols. SSBs may be placed on particular, defined subframes/slots. In one example, within a 0.25 ms period, the two slots may include SSBs and OFDM symbols 4-7 may be associated with a first SSB, OFDM symbols 8-11 may be associated with a second SSB, OFDM symbols 16-19 may be associated with a third SSB, and OFDM symbols 20-23 may be associated with a fourth SSB.

As illustrated in example 650 of FIG. 6B, for 240 kHz SCS and PRACH sequence length L=64, within 20 ms, there may be twenty 1 ms subframes. Each 1 ms subframe may include eighty 0.0625 ms slots and each 0.25 ms period may include 56 OFDM symbols. SSBs may be placed on certain defined subframes/slots. In one example, within a 0.25 ms period, the four slots may include SSBs and OFDM symbols 8-11 may be associated with a first SSB, OFDM symbols 12-15 may be associated with a second SSB, OFDM symbols 16-19 may be associated with a third SSB, OFDM symbols 20-23 may be associated with a fourth SSB, OFDM symbols 32-35 may be associated with a fifth SSB, OFDM symbols 36-39 may be associated with a sixth SSB, OFDM symbols 40-43 may be associated with a seventh SSB, and OFDM symbols 44-47 may be associated with an eighth SSB.

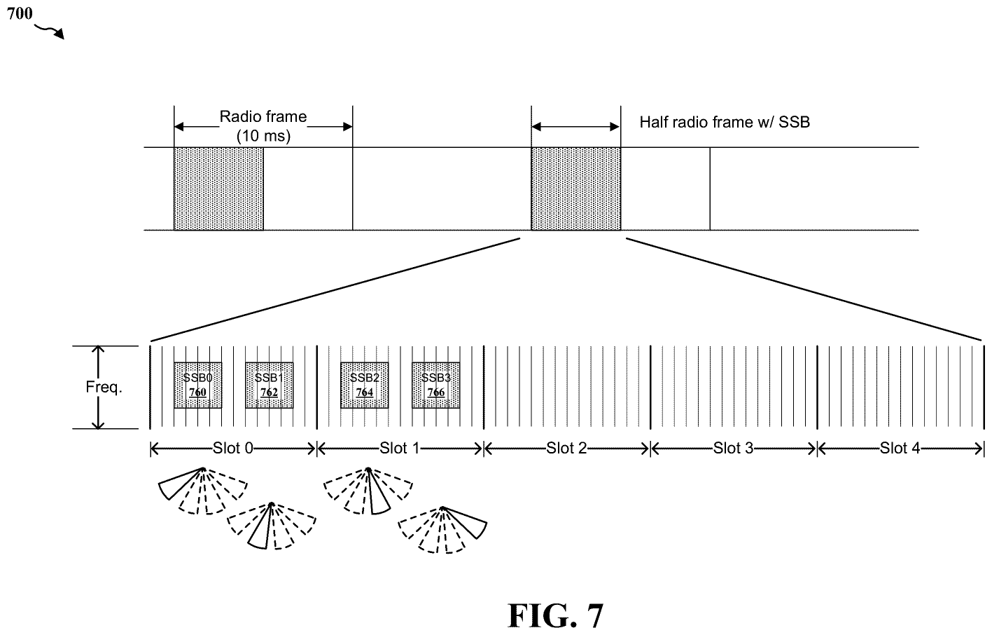

FIG. 7 illustrates an example of beam-sweeping 700. The network node may transmit the SSBs on different beams in different directions in a time division multiplexing (TDM) fashion. That is, the network node may be configured to transmit multiple SSBs, where the multiple SSBs are transmitted on different beams sequentially in different directions. Here, half of a radio frame is configured with the SSB beam-sweeping, and first two slots are configured with four SSBs; a first SSB0 760, a second SSB1 762, a third SSB 764, and a fourth SSB 766. The network node may sequentially transmit the first SSB0 760 on a first beam in a first direction, the second SSB0 762 on a second beam in a second direction, the third SSB0 764 on a third beam in a third direction, and the fourth SSB3 766 on a fourth beam in a fourth direction. The network including the network node may indicate to the UEs whether the network supports the physical layer security. That is, the network node may use the SSB to notify the UEs that the network node supports the physical layer security.

In some aspects, the network node may indicate that the network node supports the physical layer security in the SSB. In one aspect, the PSS or the SSS of the SSB may indicate that the network node may support the physical layer security. In one example, the network node may add one or more sequences in the PSS or the SSS to indicate the support of physical security by the network. In another example, the allocation of the sequences of the PSS or the SSS to the REs of the SSB may be a different placement in order to indicate the network support for physical (PHY) security. As an example, an SSB that does not indicate support for the PHY security may have the sequences allocated to REs starting from a highest RE, whereas an SSB indicating support for the PHY security may have the sequences allocated to the REs starting from a lowest RE. These two types of allocations are merely examples, and any difference in allocation of the sequences to the REs may be used to differentiate between an SSB indicating support for the PHY security and an SSB that does not indicate support for the PHY security. In another aspect, the PBCH DM-RS may have a pattern or configuration that indicate that the network node supports the physical layer security. For example, an SSB indicating that the network supports the PHY security may have DM-RS with a different location, density, and/or periodicity, etc., than an SSB that does not indicate support for the PHY security.

In some aspects, the network node may indicate that the network node supports the physical layer security with the synchronization (sync) raster on which the SSB is transmitted. That is, to indicate that the network node supports the physical layer security, the network node may transmit the SSB on a different sync raster than an SSB that does not indicate support for the PHY security. In some aspects, sync rasters may be changed or grouped into sync raster that are associated with network support for the PHY security and sync raster that are not associated with network support for the PHY security. In some aspects, new, e.g., additional, rasters may be added with the new rasters being associated with network support for PHY security. The network node may transmit an SSB on the new raster, or a raster from a group associated with support for the PHY security, to indicate that the network node supports the physical layer security. In one example, when new sync rasters are added to indicate that the network node may support the physical layer security, the newly added sync rasters may be used to indicate the security level. For example, different sync rasters may be associated with different levels of PHY security, e.g., a first sync raster being associated with a first level of PHY security, a second sync raster being associated with a second level of PHY security, a third sync raster being associated with a third level of PHY security, etc. The network may indicate a particular level of PHY security by transmitting the SSB on the corresponding sync raster that is associated with the particular level of PHY security.

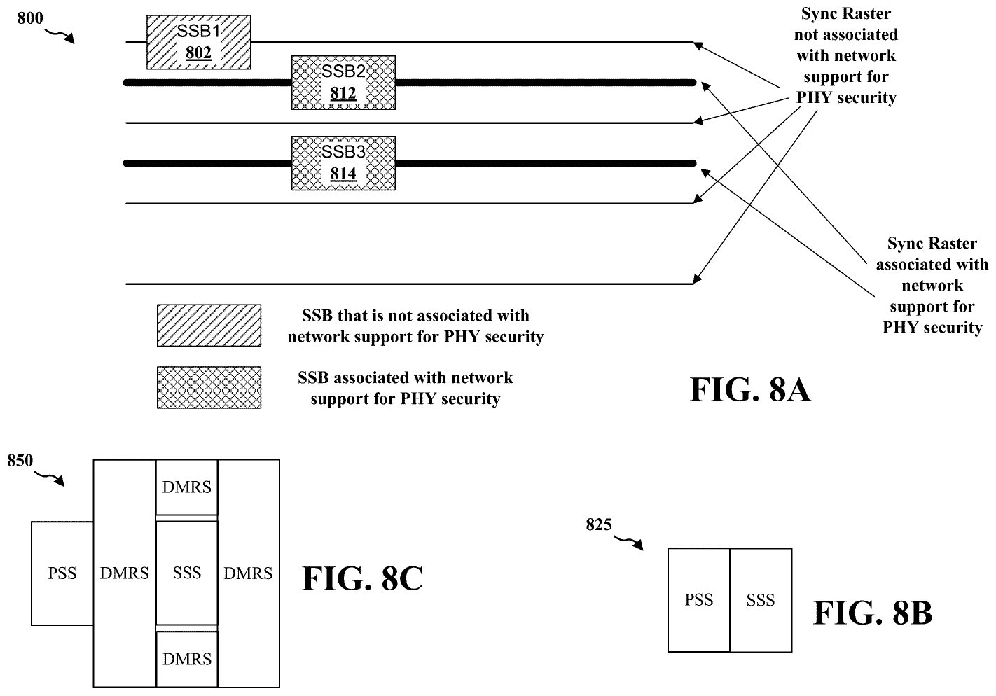

FIG. 8A illustrates an example of a raster grid 800 including different rasters for indicating the physical layer security. FIG. 8A illustrates that a first set of rasters may be associated with network support for the PHY security, and an SSB (e.g., 812 or 814) transmits on one of the first set of rasters may indicate to a receiving UE that the network supports the PHY security. A second set of rasters may not be associated with network support for the PHY security. An SSB (e.g., 802) transmitted on one of the second set of rasters may not indicate support for the PHY security. In some aspects, the second set of rasters may be referred to as regular rasters, and the first set of rasters may be new rasters or additional rasters. As an example, an additional set of one or more raster grids 800 may be provided, designated, or configured, to indicate that the network node supports the physical layer security. An additional raster that is associated with the network support for PHY security may be referred to a secure sync raster. In some aspects, different sync rasters may indicate the security level of the PHY security supported by the network. As an example, the SSB 812 may be on a sync raster associated with a first level of PHY security supported by the network, and the SSB 814 may be on a sync raster associated with a second level of PHY security supported by the network. The network node may send one or more SSBs on both a raster that does not indicate network support for the PHY security and a secure sync raster that does indicate network support for the PHY security.

In one aspect, a regular UEs, i.e., may refer to a UE that does not support the secure communication based on the physical layer or that does not support a determination of whether the network supports the PHY security based on SSB reception, may assume that network node is sending the SSB signals on the regular raster grid. That is, a regular UE may disregard the SSBs transmitted on the secure sync raster, and may not determine that the network supports the PHY security and/or may not attempt to determine a secret key to apply PHY security with the network. In another aspect, a UE that support the communication with PHY security, and/or that support a determination of whether the network supports the PHY security based on SSB reception, may monitor both rasters including the sync rasters that do not indicate network support for the PHY security and the secure sync rasters. The UE may search for an SSB both rasters including at least one sync raster that is not associated with network support for the PHY security and at least one secure sync raster associated with network support for the PHY security.

A UE that may support the secure communications with PHY security may first perform the sync search on the secure sync raster. If the search on the secure sync raster fails, the UE may understand that the network node may not support the secure communication using PHY layer techniques, and use the sync raster grid that is not associated with network support for the PHY security. If the search on the secure sync raster was successful, the UE may understand that the station supports the secure communication using PHY layer techniques, and further move to searching on the regular raster grid for random access procedures. For example, at least one of a second SSB 812 or a third SSB 814 may be transmitted on the new secure sync raster grid to indicate that the network node supports the physical layer security, and a first SSB 802 may be transmitted on a sync raster that is not associated with network support for the PHY security.

In some aspects, the sync rasters associated with network support for PHY security may be configured in between frequency locations of the rasters that do not indicate network support for PHY security or in preconfigured locations. In one example, the new sync raster grid may include one (1) new sync raster in secure raster grid, and the one new sync raster may represent a one bit that may be used to indicate whether the network node may support the physical layer security. For example, the second SSB 812 may be provided on the secure sync raster representing the value of 1, indicating that the network node may support the physical layer security. In another example, the new sync raster grid may include two (2) new sync rasters in secure raster grid, and the two new sync raster may represent two bits that may be used to identifying a type of the security or a level of the security.

That is, any new SSBs on the two new sync rasters may indicate that the network node supports the physical layer security, and the value represented by the SSBs carried on the two new sync rasters may indicate the type or the level of the physical layer security. In one example, the second SSB 812 and a third SSB 814 may be provided on the secure sync raster representing the value of two (2) bits, which may indicate certain type of security level identified in spec. In another example, the second SSB 812 or the third SSB 814 may be provided on the secure sync raster representing a bitmap, and the SSBs transmitted in the first secure sync raster may indicate the Security Level 1 (high/med/low or others), and the second secure sync raster may indicate the Security Level 2, etc. In another aspect, the combination of the second SSB 812 on the first secure sync raster and the third SSB 814 on the second secure sync raster may represent 4 levels of security indication with 00 indicating no PHY security is supported by the network node. The UE may first determine that the network node supports the physical layer security based on the SSB received on the secure sync rasters, and may further determine the level of security (high/med/low or other levels) based on which secure sync rasters within the secure sync raster grid the SSB is received.

The SSB design, structure, or format for secret key extraction, or for indication of network support for the PHY security may have various configurations. In one aspect, the configuration of the SSB indicating support for the PHY security, or transmitted on a raster associated with support for the PHY security, may be the same as an SSB on a raster that is not associated with network support for the PHY security. In another aspect, the SSB may have a different design, structure, or format than as an SSB on a raster that is not associated with network support for the PHY security. As an example, an SSB on a raster associated with network support for the PHY security may be a simplified SSB. In one example, the SSB may include the PSS or the SSS without the PBCH, e.g., as illustrated in the example diagram 825 in FIG. 8B. In some aspects, the sequence allocation to the REs may be different for the two SSBs. In another aspect, the PBCH DM-RS may be provided with increased DM-RS REs in the SSB indicating support for the PHY security, or transmitted on a raster associated with support for the PHY security. In some aspects, a majority of PBCH resources may be filled with DM-RS. In some aspects, the SSB indicating support for the PHY security, or transmitted on a raster associated with support for the PHY security, may include SSS, PSS, and DM-RS without additional PBCH data, e.g., as illustrated in the example 850 in FIG. 8C. In another aspect, the SSB indicating support for the PHY security, or transmitted on a raster associated with support for the PHY security, may include the PSS, the SSS, and the DM-RS, e.g., as described in connection with FIG. 5B, and with an increased density of DM-RS in the PBCH.

In some aspects, the network node may indicate that the network node may support the physical layer security with an advanced SSB. The advanced SSB may have the same structure as the regular SSB including the PSS, the SSS, and the MIB, and adding further more DM-RS symbols or RBs for enhanced channel estimation for secret key extraction based on SSB.

The configuration of the SSB in the secure sync rasters may be different from the configuration of the SSB in the rasters that are not associated with network support for PHY security. For example, the SSB may include a configuration of a different SSB periodicity, as indicated in a parameter, e.g., ssb-PeriodicityServingCell.

In some aspects, the network node may configure a new type of SSB maintaining the cell info as well as MIB and signaling with higher DM-RS density (in the time or frequency domains) or larger number of resources, i.e., more RBs and symbols, for applications where the SSB is used for secret key extraction from channel. That is, the new type of SSB may have a higher DM-RS density, where the SSB may be used for secret key extraction.

The network node may ask the UE to use the SSB signal to extract the channel and use a modified version of the estimated channel, after quantization, as the secret key bits used to secure the DCI, UCI, or any data channel.

In some aspects, in a connecting mode, the SRS resources or the channel state information reference signal (CSI-RS) resources used for obtaining the secret key bits from channel reciprocity may be quasi co-located (QCLed) with those beams within the secure sync raster grids. Therefore, the indication may refer to the SSBs in the new sync rasters. That is, the reference signal that the network node may use to obtain the secret key bits may be QCLed with the SSB beams on the secure sync raster grids.

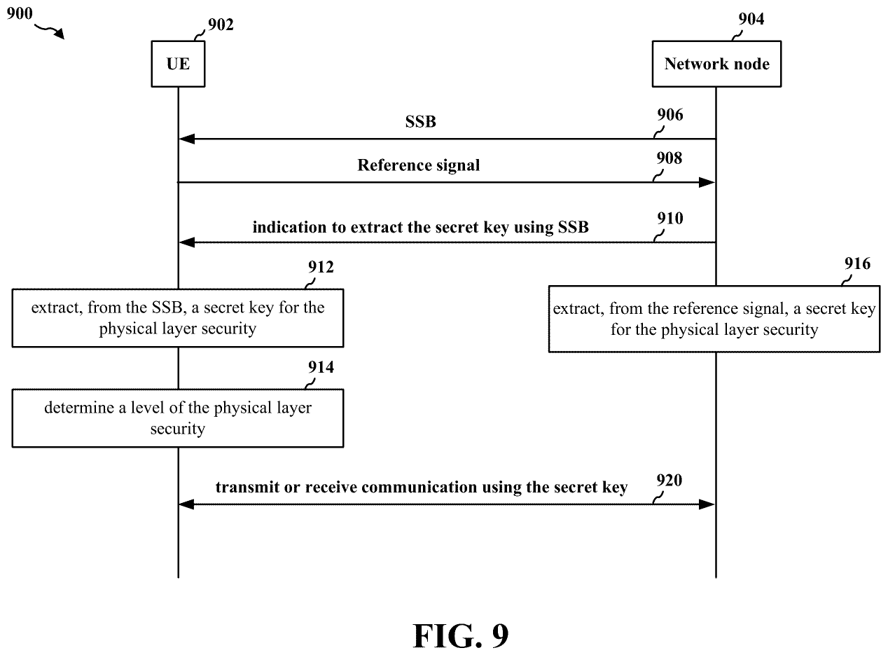

FIG. 9 is a call-flow diagram 900 of a method of wireless communication. The call-flow diagram 900 may include a UE 902 and a network node 904. The network node 904 may transmit an SSB indicating that the network supports physical layer security, and the UE 902 may extract the secret key for the physical layer security based on the received SSB indicating that the network supports the physical layer security. The network node 904 may indicate a level of the physical layer security using the SSB, and the UE 902 may determine the level of the physical layer security based on the received SSB.

At 906, the network node 904 may transmit, to the UE 902, an SSB that indicates that the network may support the physical layer security. The UE 902 may receive, from the network node 904, an SSB that may indicate that the network may support the physical layer security. In some aspects, the indication that the network supports the physical layer security may be included in the SSB. In one aspect, the SSB may include a sequence indicating that the network supports the physical layer security. In another aspect, the SSB may include an allocation of one or more sequences to a set of resource elements, the allocation indicating that the network supports the physical layer security. In another aspect, the SSB may include a PBCH DM-RS pattern indicating the network supports the physical layer security.

In some aspects, a synchronization raster of the SSB may indicate that the network supports the physical layer security. The SSB may have an SSB structure common to the SSB on the synchronization raster indicating that the network supports the physical layer security and an additional SSB on an additional synchronization raster that does not indicate support for the physical layer security, or a different SSB structure than additional SSB on an additional synchronization raster that does not indicate support for the physical layer security. In one aspect, the SSB on the synchronization raster indicating that the network supports the physical layer security may have a different configuration than additional SSB on an additional synchronization raster that does not indicate support for the physical layer security. Here, the different configuration may include a different periodicity. In another aspect, the SSB on the synchronization raster indicating that the network supports the physical layer security may include a higher number of DM-RS resources than additional SSB on an additional synchronization raster that does not indicate support for the physical layer security. In one aspect, the synchronization raster indicating that the network supports the physical layer security may have a frequency located between other synchronization rasters that do not indicate support for the physical layer security.

At 908, the UE 902 may transmit the reference signal to the network node 904, and the network node 904 may receive the reference signal from the UE 902. Here, the reference signal may be used by the network node 904 to extract the secret key at 916. The reference signal for extracting the secret key may have a QCL relationship with one of more beams of the SSB on the synchronization raster.

At 910, the network node 904 may transmit, to the UE 902, an indication from the network node 904 to extract the secret key using the SSB, and the UE 902 may receive, from the network node 904, an indication from the network node 904 to extract the secret key using the SSB. The UE 902 may extract the secret key from the SSB at 912 based on receiving the indication to extract the secret key using the SSB.

At 912, the UE 902 may extract a secret key for the physical layer security with the network in response to the SSB indicating that the network supports the physical layer security. Here, the secret key extraction may refer to extracting secret key from channel randomness. The UE 902 may estimate the channel of the received SSBs and obtain certain metric based on the estimated channels, and the secret key may be determined or generated based on the obtained metric of the estimated channels.

At 914, the UE 902 may determine a level of the physical layer security supported by the network based on the synchronization raster on which the SSB is received. That is, the synchronization raster may indicate a security level, and the UE 902 may determine the security level based on the synchronization raster of the SSB received at 906. Here, the different synchronization rasters may be associated with different levels of the physical layer security supported by the network, or the different synchronization rasters may be associated with different levels of the physical layer security supported by the network.

At 916, the network node 904 may extract a secret key based on a reference signal received from a UE 902. The SSB and the reference signal may be configured so that the secret key extracted by the network node 904 may be the same as the secret key extracted by the UE 902 using the SSB. Therefore, the network node 904 and the UE 902 may provide the physical layer security using the same secret key without repeated communication of pilot signals or a key refinement procedure.

At 920, the network node 904 and the UE 902 may transmit or receive communication with each other using the secret key. Accordingly, the communication transmitted or received to each other may be protected at the physical layer level using the secret key extracted from the received SSB or the RS. The SSB and the reference signal may be configured so that the secret key extracted by the network node 904 using the reference signal may be the same as the secret key extracted by the UE 902 using the SSB. Therefore, the network node 904 and the UE 902 may provide the physical layer security using the same secret key without repeated communication of pilot signals or a key refinement procedure.

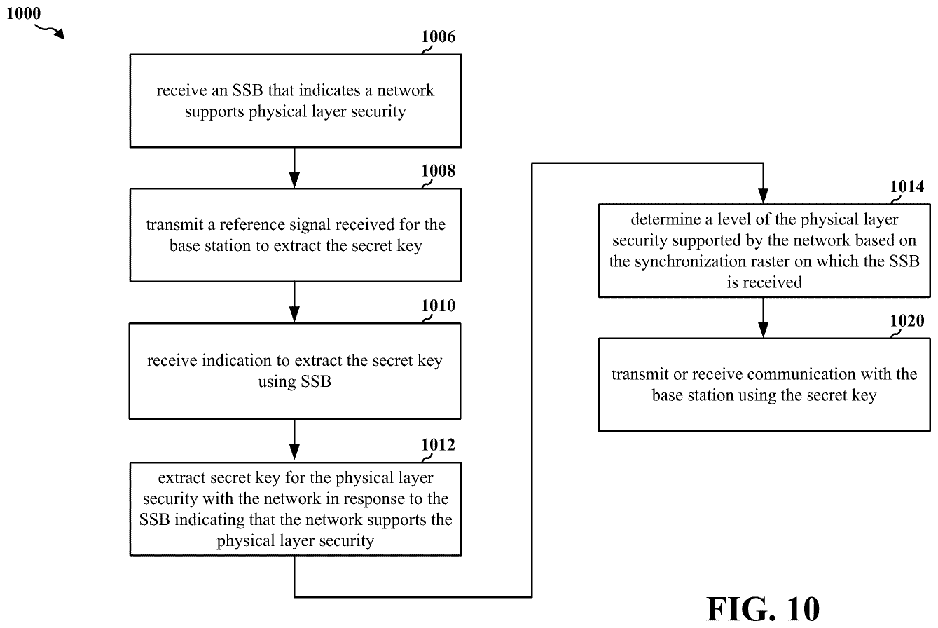

FIG. 10 is a flowchart 1000 of a method of wireless communication. The method may be performed by a UE (e.g., the UE 104/902; the apparatus 1402). The UE may extract the secret key for the physical layer security based on receiving the SSB indicating that the network may support the physical layer security. The UE may also determine the level of the physical layer security based on the received SSB.

At 1006, the UE may receive, from the network node, an SSB that may indicate that the network may support the physical layer security. In some aspects, the indication that the network may support the physical layer security may be included in the SSB. In one aspect, the SSB may include a sequence indicating that the network supports the physical layer security. In another aspect, the SSB may include an allocation of one or more sequences to a set of resource elements, the allocation indicating that the network supports the physical layer security. In another aspect, the SSB may include a PBCH DM-RS pattern indicating the network supports the physical layer security. In some aspects, a synchronization raster of the SSB may indicate that the network supports the physical layer security. The SSB may have an SSB structure common to the SSB on the synchronization raster indicating that the network supports the physical layer security and an additional SSB on an additional synchronization raster that does not indicate support for the physical layer security, or a different SSB structure than additional SSB on an additional synchronization raster that does not indicate support for the physical layer security. In one aspect, the SSB on the synchronization raster indicating that the network supports the physical layer security may have a different configuration than additional SSB on an additional synchronization raster that does not indicate support for the physical layer security. Here, the different configuration may include a different periodicity. In another aspect, the SSB on the synchronization raster indicating that the network supports the physical layer security may include a higher number of DM-RS resources than additional SSB on an additional synchronization raster that does not indicate support for the physical layer security. In one aspect, the synchronization raster indicating that the network supports the physical layer security may have a frequency located between other synchronization rasters that do not indicate support for the physical layer security. For example, at 906, the UE 902 may receive, from the network node 904, an SSB that may indicate that the network may support the physical layer security. Furthermore, 1006 may be performed by a physical security secret key component 198.

At 1008, the UE may transmit the reference signal to the network node. Here, the reference signal may be used by the network node to extract the secret key. The reference signal for extracting the secret key may have a QCL relationship with one of more beams of the SSB on the synchronization raster. For example, at 908, the UE 902 may transmit the reference signal to the network node 904. Furthermore, 1008 may be performed by the physical security secret key component 198.

At 1010, the UE may receive, from the network node, an indication from the network node to extract the secret key using the SSB. UE may extract the secret key from the SSB at 1012 based on receiving the indication to extract the secret key using the SSB. For example, at 910, the UE 902 may receive, from the network node 904, an indication from the network node 904 to extract the secret key using the SSB. Furthermore, 1010 may be performed by the physical security secret key component 198.

At 1012, the UE may extract a secret key for the physical layer security with the network in response to the SSB indicating that the network supports the physical layer security. Here, the secret key extraction may refer to extracting secret key from channel randomness. The UE may estimate the channel of the received SSBs and obtain certain metric based on the estimated channels, and the secret key may be determined or generated based on the obtained metric of the estimated channels. For example, at 912, the UE 902 may extract a secret key for the physical layer security with the network in response to the SSB indicating that the network supports the physical layer security. Furthermore, 1012 may be performed by the physical security secret key component 198.

At 1014, the UE may determine a level of the physical layer security supported by the network based on the synchronization raster on which the SSB is received. That is, the synchronization raster may indicate a security level, and the UE may determine the security level based on the synchronization raster of the SSB received at 1006. Here, the different synchronization rasters may be associated with different levels of the physical layer security supported by the network, or the different synchronization rasters may be associated with different levels of the physical layer security supported by the network. For example, at 914, the UE 902 may determine a level of the physical layer security supported by the network based on the synchronization raster on which the SSB is received. Furthermore, 1014 may be performed by the physical security secret key component 198.

At 1020, the UE may transmit or receive communication with the network node using the secret key. Accordingly, the communication transmitted or received to each other may be protected at the physical layer level using the secret key extracted from the received SSB or the RS. The SSB and the reference signal may be configured so that the secret key extracted by the network node using the reference signal may be the same as the secret key extracted by the UE using the SSB. Therefore, the network node and the UE may provide the physical layer security using the same secret key without repeated communication of pilot signals or a key refinement procedure. For example, at 920, the UE 902 may transmit or receive communication with the network node 904 using the secret key. Furthermore, 1020 may be performed by the physical security secret key component 198.

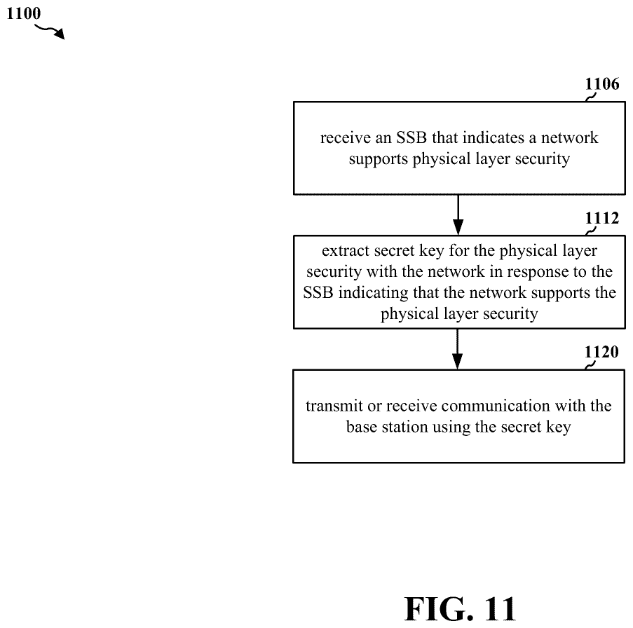

FIG. 11 is a flowchart 1100 of a method of wireless communication. The method may be performed by a UE (e.g., the UE 104/902; the apparatus 1402). The UE may extract the secret key for the physical layer security based on receiving the SSB indicating that the network may support the physical layer security. The UE may also determine the level of the physical layer security based on the received SSB.

At 1106, the UE may receive, from the network node, an SSB that may indicate that the network may support the physical layer security. In some aspects, the indication that the network may support the physical layer security may be included in the SSB. In one aspect, the SSB may include a sequence indicating that the network supports the physical layer security. In another aspect, the SSB may include an allocation of one or more sequences to a set of resource elements, the allocation indicating that the network supports the physical layer security. In another aspect, the SSB may include a PBCH DM-RS pattern indicating the network supports the physical layer security. In some aspects, a synchronization raster of the SSB may indicate that the network supports the physical layer security. The SSB may have an SSB structure common to the SSB on the synchronization raster indicating that the network supports the physical layer security and an additional SSB on an additional synchronization raster that does not indicate support for the physical layer security, or a different SSB structure than additional SSB on an additional synchronization raster that does not indicate support for the physical layer security. In one aspect, the SSB on the synchronization raster indicating that the network supports the physical layer security may have a different configuration than additional SSB on an additional synchronization raster that does not indicate support for the physical layer security. Here, the different configuration may include a different periodicity. In another aspect, the SSB on the synchronization raster indicating that the network supports the physical layer security may include a higher number of DM-RS resources than additional SSB on an additional synchronization raster that does not indicate support for the physical layer security. In one aspect, the synchronization raster indicating that the network supports the physical layer security may have a frequency located between other synchronization rasters that do not indicate support for the physical layer security. For example, at 906, the UE 902 may receive, from the network node 904, an SSB that may indicate that the network may support the physical layer security. Furthermore, 1106 may be performed by a physical security secret key component 198.

At 1112, the UE may extract a secret key for the physical layer security with the network in response to the SSB indicating that the network supports the physical layer security. Here, the secret key extraction may refer to extracting secret key from channel randomness. The UE may estimate the channel of the received SSBs and obtain certain metric based on the estimated channels, and the secret key may be determined or generated based on the obtained metric of the estimated channels. For example, at 912, the UE 902 may extract a secret key for the physical layer security with the network in response to the SSB indicating that the network supports the physical layer security. Furthermore, 1112 may be performed by the physical security secret key component 198.

At 1120, the UE may transmit or receive communication with the network node using the secret key. Accordingly, the communication transmitted or received to each other may be protected at the physical layer level using the secret key extracted from the received SSB or the RS. The SSB and the reference signal may be configured so that the secret key extracted by the network node using the reference signal may be the same as the secret key extracted by the UE using the SSB. Therefore, the network node and the UE may provide the physical layer security using the same secret key without repeated communication of pilot signals or a key refinement procedure. For example, at 920, the UE 902 may transmit or receive communication with the network node 904 using the secret key. Furthermore, 1120 may be performed by the physical security secret key component 198.

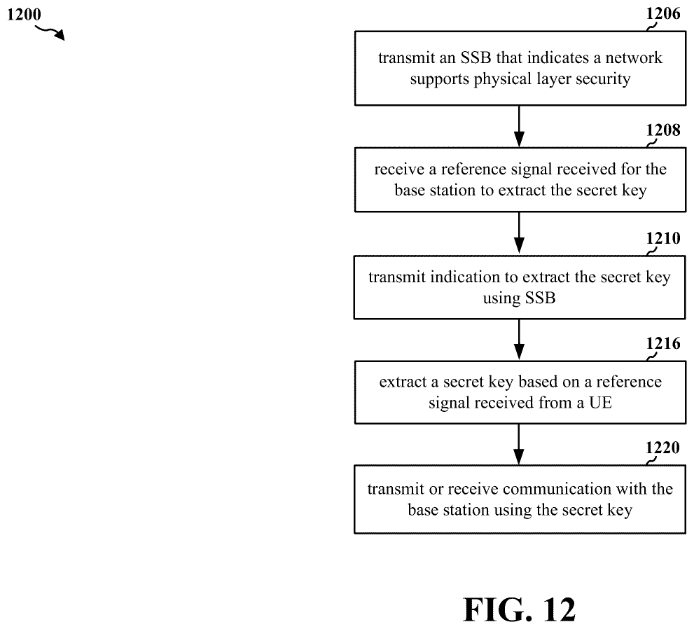

FIG. 12 is a flowchart 1200 of a method of wireless communication. The method may be performed by a network node (e.g., the base station 102; the network node 904; the network entity 1502). The network node may transmit an SSB indicating that the network may support physical layer security. The network node may also indicate a level of the physical layer security using the SSB.

At 1206, the network node may transmit, to the UE, an SSB that may indicate that the network may support the physical layer security. In some aspects, the indication that the network may support the physical layer security may be included in the SSB. In one aspect, the SSB may include a sequence indicating that the network supports the physical layer security. In another aspect, the SSB may include an allocation of one or more sequences to a set of resource elements, the allocation indicating that the network supports the physical layer security. In another aspect, the SSB may include a PBCH DM-RS pattern indicating the network supports the physical layer security. In some aspects, a synchronization raster of the SSB may indicate that the network supports the physical layer security. The SSB may have an SSB structure common to the SSB on the synchronization raster indicating that the network supports the physical layer security and an additional SSB on an additional synchronization raster that does not indicate support for the physical layer security, or a different SSB structure than additional SSB on an additional synchronization raster that does not indicate support for the physical layer security. In one aspect, the SSB on the synchronization raster indicating that the network supports the physical layer security may have a different configuration than additional SSB on an additional synchronization raster that does not indicate support for the physical layer security. Here, the different configuration may include a different periodicity. In another aspect, the SSB on the synchronization raster indicating that the network supports the physical layer security may include a higher number of DM-RS resources than additional SSB on an additional synchronization raster that does not indicate support for the physical layer security. In one aspect, the synchronization raster indicating that the network supports the physical layer security may have a frequency located between other synchronization rasters that do not indicate support for the physical layer security. For example, at 906, the network node 904 may transmit, to the UE 902, an SSB that may indicate that the network may support the physical layer security. Furthermore, 1206 may be performed by a physical security secret key component 199.

At 1208, the network node may receive the reference signal from the UE. Here, the reference signal may be used by the network node to extract the secret key at 1016. The reference signal for extracting the secret key may have a QCL relationship with one of more beams of the SSB on the synchronization raster. The UE may extract the secret key from the SSB based on receiving the indication to extract the secret key using the SSB. For example, at 908, the network node 904 may receive the reference signal from the UE 902. Furthermore, 1208 may be performed by the physical security secret key component 199.

At 1210, the network node may transmit, to the UE, an indication from the network node to extract the secret key using the SSB. For example, at 910, the network node 904 may transmit, to the UE 902, an indication from the network node 904 to extract the secret key using the SSB. Furthermore, 1210 may be performed by the physical security secret key component 199.

At 1216, the network node may extract a secret key based on a reference signal received from the UE. The SSB and the reference signal may be configured so that the secret key extracted by the network node may be the same as the secret key extracted by the UE using the SSB. Therefore, the network node and the UE may provide the physical layer security using the same secret key without repeated communication of pilot signals or a key refinement procedure. For example, at 916, the network node 904 may extract a secret key based on a reference signal received from a UE 902. Furthermore, 1216 may be performed by the physical security secret key component 199.

At 1220, the network node may transmit or receive communication with the UE using the secret key. Accordingly, the communication transmitted or received to each other may be protected at the physical layer level using the secret key extracted from the received SSB or the RS. The SSB and the reference signal may be configured so that the secret key extracted by the network node using the reference signal may be the same as the secret key extracted by the UE using the SSB. Therefore, the network node and the UE may provide the physical layer security using the same secret key without repeated communication of pilot signals or a key refinement procedure. For example, at 920, the network node 904 may transmit or receive communication with the UE 902 using the secret key. Furthermore, 1220 may be performed by the physical security secret key component 199.

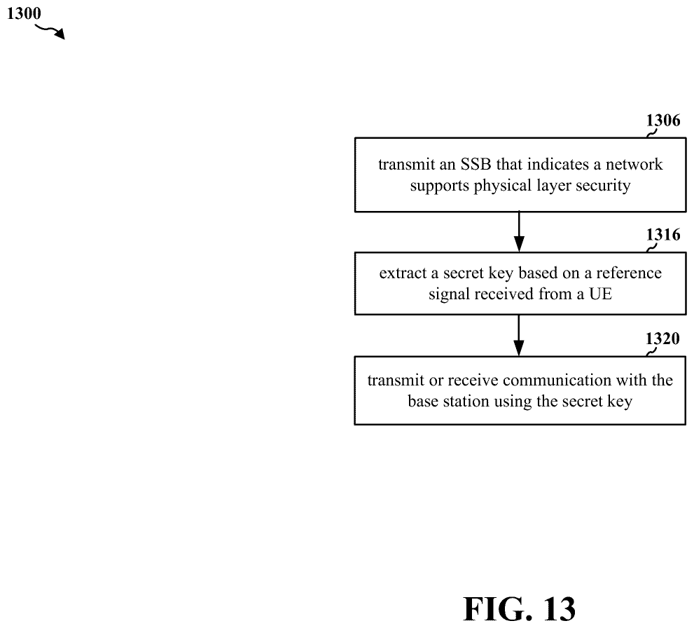

FIG. 13 is a flowchart 1300 of a method of wireless communication. The method may be performed by a network node (e.g., the base station 102; the network node 904; the network entity 1502). The network node may transmit an SSB indicating that the network may support physical layer security. The network node may also indicate a level of the physical layer security using the SSB.

At 1306, the network node may transmit, to the UE, an SSB that may indicate that the network may support the physical layer security. In some aspects, the indication that the network may support the physical layer security may be included in the SSB. In one aspect, the SSB may include a sequence indicating that the network supports the physical layer security. In another aspect, the SSB may include an allocation of one or more sequences to a set of resource elements, the allocation indicating that the network supports the physical layer security. In another aspect, the SSB may include a PBCH DM-RS pattern indicating the network supports the physical layer security. In some aspects, a synchronization raster of the SSB may indicate that the network supports the physical layer security. The SSB may have an SSB structure common to the SSB on the synchronization raster indicating that the network supports the physical layer security and an additional SSB on an additional synchronization raster that does not indicate support for the physical layer security, or a different SSB structure than additional SSB on an additional synchronization raster that does not indicate support for the physical layer security. In one aspect, the SSB on the synchronization raster indicating that the network supports the physical layer security may have a different configuration than additional SSB on an additional synchronization raster that does not indicate support for the physical layer security. Here, the different configuration may include a different periodicity. In another aspect, the SSB on the synchronization raster indicating that the network supports the physical layer security may include a higher number of DM-RS resources than additional SSB on an additional synchronization raster that does not indicate support for the physical layer security. In one aspect, the synchronization raster indicating that the network supports the physical layer security may have a frequency located between other synchronization rasters that do not indicate support for the physical layer security. For example, at 906, the network node 904 may transmit, to the UE 902, an SSB that may indicate that the network may support the physical layer security. Furthermore, 1306 may be performed by a physical security secret key component 199.

At 1316, the network node may extract a secret key based on a reference signal received from the UE. The SSB and the reference signal may be configured so that the secret key extracted by the network node may be the same as the secret key extracted by the UE using the SSB. Therefore, the network node and the UE may provide the physical layer security using the same secret key without repeated communication of pilot signals or a key refinement procedure. For example, at 916, the network node 904 may extract a secret key based on a reference signal received from a UE 902. Furthermore, 1316 may be performed by the physical security secret key component 199.

At 1320, the network node may transmit or receive communication with the UE using the secret key. Accordingly, the communication transmitted or received to each other may be protected at the physical layer level using the secret key extracted from the received SSB or the RS. The SSB and the reference signal may be configured so that the secret key extracted by the network node using the reference signal may be the same as the secret key extracted by the UE using the SSB. Therefore, the network node and the UE may provide the physical layer security using the same secret key without repeated communication of pilot signals or a key refinement procedure. For example, at 920, the network node 904 may transmit or receive communication with the UE 902 using the secret key. Furthermore, 1320 may be performed by the physical security secret key component 199.

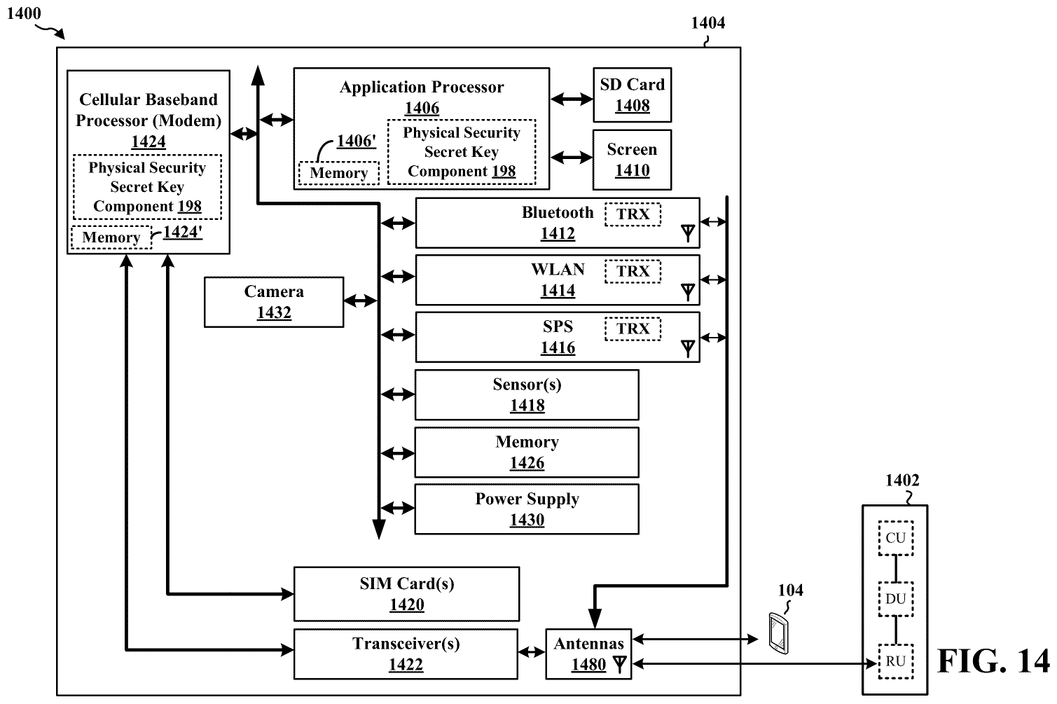

FIG. 14 is a diagram 1400 illustrating an example of a hardware implementation for an apparatus 1404. The apparatus 1404 may be a UE, a component of a UE, or may implement UE functionality. In some aspects, the apparatus 1404 may include a cellular baseband processor 1424 (also referred to as a modem) coupled to one or more transceivers 1422 (e.g., cellular RF transceiver). The cellular baseband processor 1424 may include on-chip memory 1424′. In some aspects, the apparatus 1404 may further include one or more subscriber identity modules (SIM) cards 1420 and an application processor 1406 coupled to a secure digital (SD) card 1408 and a screen 1410. The application processor 1406 may include on-chip memory 1406′. In some aspects, the apparatus 1404 may further include a Bluetooth module 1412, a WLAN module 1414, an SPS module 1416 (e.g., GNSS module), one or more sensor modules 1418 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1426, a power supply 1430, and/or a camera 1432. The Bluetooth module 1412, the WLAN module 1414, and the SPS module 1416 may include an on-chip transceiver (TRX) (or in some cases, just a receiver (RX)). The Bluetooth module 1412, the WLAN module 1414, and the SPS module 1416 may include their own dedicated antennas and/or utilize the antennas 1480 for communication. The cellular baseband processor 1424 communicates through the transceiver(s) 1422 via one or more antennas 1480 with the UE 104 and/or with an RU associated with an apparatus 1402. The cellular baseband processor 1424 and the application processor 1406 may each include a computer-readable medium/memory 1424′, 1406′, respectively. The additional memory modules 1426 may also be considered a computer-readable medium/memory. Each computer-readable medium/memory 1424′, 1406′, 1426 may be non-transitory. The cellular baseband processor 1424 and the application processor 1406 are each responsible for general processing, including the execution of software stored on the computer-readable medium/memory. The software, when executed by the cellular baseband processor 1424/application processor 1406, causes the cellular baseband processor 1424/application processor 1406 to perform the various functions described supra. The computer-readable medium/memory may also be used for storing data that is manipulated by the cellular baseband processor 1424/application processor 1406 when executing software. The cellular baseband processor 1424/application processor 1406 may be a component of the UE 350 and may include the memory 360 and/or at least one of the TX processor 368, the RX processor 356, and the controller/processor 359. In one configuration, the apparatus 1404 may be a processor chip (modem and/or application) and include just the cellular baseband processor 1424 and/or the application processor 1406, and in another configuration, the apparatus 1404 may be the entire UE (e.g., see 350 of FIG. 3) and include the additional modules of the apparatus 1404.

As discussed supra, the component 198 is configured to receive, from a base station, an SSB that indicates a network supports physical layer security, extract a secret key for the physical layer security with the network in response to the SSB indicating that the network supports the physical layer security, and transmit or receive communication with the base station using the secret key. The component 198 may be within the cellular baseband processor 1424, the application processor 1406, or both the cellular baseband processor 1424 and the application processor 1406. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1404 may include a variety of components configured for various functions. In one configuration, the apparatus 1404, and in particular the cellular baseband processor 1424 and/or the application processor 1406, includes means for receiving, from a network node, an SSB that indicates a network supports physical layer security, means for extracting a secret key for the physical layer security with the network in response to the SSB indicating that the network supports the physical layer security, and means for transmitting or receiving communication with the network node using the secret key. In one configuration, the SSB includes a sequence indicating that the network supports the physical layer security. In one configuration, the SSB includes an allocation of one or more sequences to a set of resource elements, the allocation indicating that the network supports the physical layer security. In one configuration, the SSB includes a PBCH DM-RS pattern indicating the network supports the physical layer security. In one configuration, a synchronization raster of the SSB indicates that the network supports the physical layer security. In one configuration, an SSB structure is common to the SSB on the synchronization raster indicating that the network supports the physical layer security and an additional SSB on an additional synchronization raster that does not indicate support for the physical layer security. In one configuration, the SSB on the synchronization raster indicating that the network supports the physical layer security has a different SSB structure than additional SSB on an additional synchronization raster that does not indicate support for the physical layer security. In one configuration, the SSB on the synchronization raster indicating that the network supports the physical layer security has a different configuration than additional SSB on an additional synchronization raster that does not indicate support for the physical layer security. In one configuration, the different configuration includes a different periodicity. In one configuration, the SSB on the synchronization raster indicating that the network supports the physical layer security include a higher number of DM-RS resources than additional SSB on an additional synchronization raster that does not indicate support for the physical layer security. In one configuration, the synchronization raster indicates a security level. In one configuration, different synchronization rasters are associated with different levels of the physical layer security supported by the network. In one configuration, the apparatus 1404, and in particular the cellular baseband processor 1424 and/or the application processor 1406, further includes means for determining a level of the physical layer security supported by the network based on the synchronization raster on which the SSB is received. In one configuration, the synchronization raster indicating that the network supports the physical layer security has a frequency located between other synchronization rasters that do not indicate support for the physical layer security. In one configuration, the apparatus 1404, and in particular the cellular baseband processor 1424 and/or the application processor 1406, further includes means for receiving an indication from the network node to extract the secret key using the SSB. In one configuration, a reference signal for extracting the secret key has a QCL relationship with one of more beams of the SSB on the synchronization raster. The means may be the component 198 of the apparatus 1404 configured to perform the functions recited by the means. As described supra, the apparatus 1404 may include the TX processor 368, the RX processor 356, and the controller/processor 359. As such, in one configuration, the means may be the TX processor 368, the RX processor 356, and/or the controller/processor 359 configured to perform the functions recited by the means.

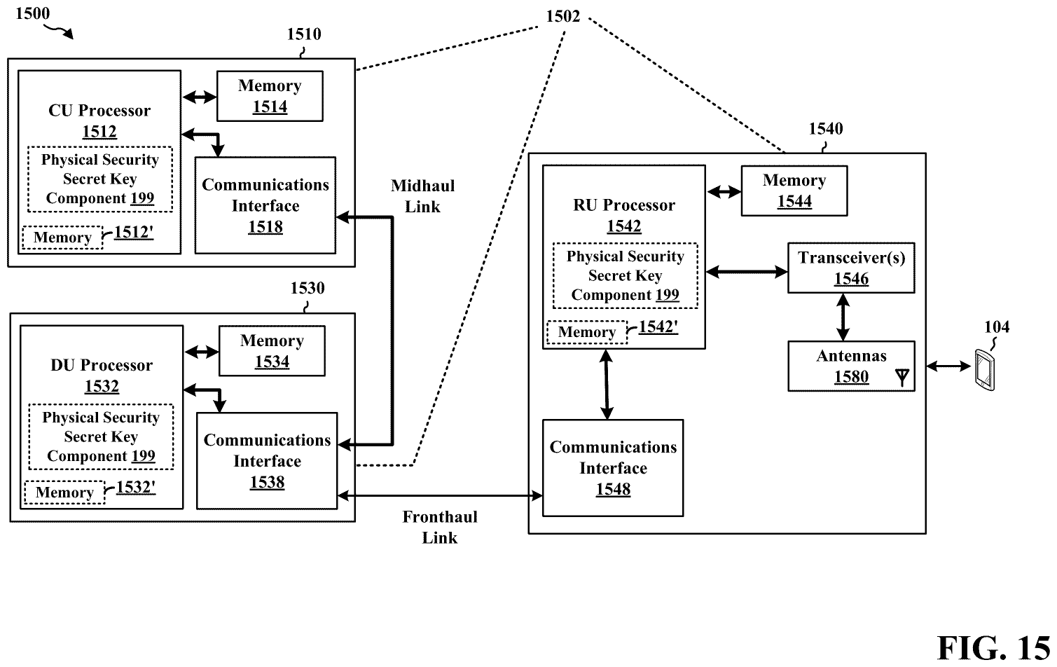

FIG. 15 is a diagram 1500 illustrating an example of a hardware implementation for a network entity 1502. The network entity 1502 may be a BS, a component of a BS, or may implement BS functionality. The network entity 1502 may include at least one of a CU 1510, a DU 1530, or an RU 1540. For example, depending on the layer functionality handled by the physical security secret key component 199, the network entity 1502 may include the CU 1510; both the CU 1510 and the DU 1530; each of the CU 1510, the DU 1530, and the RU 1540; the DU 1530; both the DU 1530 and the RU 1540; or the RU 1540. The CU 1510 may include a CU processor 1512. The CU processor 1512 may include on-chip memory 1512′. In some aspects, the CU 1510 may further include additional memory modules 1514 and a communications interface 1518. The CU 1510 communicates with the DU 1530 through a midhaul link, such as an F1 interface. The DU 1530 may include a DU processor 1532. The DU processor 1532 may include on-chip memory 1532′. In some aspects, the DU 1530 may further include additional memory modules 1534 and a communications interface 1538. The DU 1530 communicates with the RU 1540 through a fronthaul link. The RU 1540 may include an RU processor 1542. The RU processor 1542 may include on-chip memory 1542′. In some aspects, the RU 1540 may further include additional memory modules 1544, one or more transceivers 1546, antennas 1580, and a communications interface 1548. The RU 1540 communicates with the UE 104. The on-chip memory 1512′, 1532′, 1542′ and the additional memory modules 1514, 1534, 1544 may each be considered a computer-readable medium/memory. Each computer-readable medium/memory may be non-transitory. Each of the processors 1512, 1532, 1542 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the physical security secret key component 199 is configured to transmit an SSB that indicates a network supports physical layer security, extract a secret key based on a reference signal received from a UE, and transmit or receive communication using the secret key. The physical security secret key component 199 may be within one or more processors of one or more of the CU 1510, DU 1530, and the RU 1540. The physical security secret key component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1502 may include a variety of components configured for various functions. In one configuration, the network entity 1502 includes means for transmitting an SSB that indicates a network supports physical layer security, means for extracting a secret key based on a reference signal received from a UE, and means for transmitting or receiving communication using the secret key. In one configuration, the SSB includes a sequence indicating that the network supports the physical layer security. In one configuration, the SSB includes an allocation of one or more sequences to a set of resource elements, the allocation indicating that the network supports the physical layer security. In one configuration, the SSB includes a PBCH DM-RS pattern indicating that the network supports the physical layer security. In one configuration, a synchronization raster of the SSB indicates that the network supports the physical layer security. In one configuration, the network entity 1502 further includes means for transmitting at least one additional SSB on at least one different synchronization raster that does not indicate support for the physical layer security, where an SSB structure is common to the SSB on the synchronization raster indicating that the network supports the physical layer security and the at least one additional SSB on the at least one different synchronization raster that does not indicate the support for the physical layer security. In one configuration, the network entity 1502 further includes means for transmitting at least one additional SSB on at least one different synchronization raster that does not indicate support for the physical layer security, where the SSB on the synchronization raster indicating that the network supports the physical layer security has a different SSB structure than the at least one additional SSB on the at least one different synchronization raster that does not indicate the support for the physical layer security. In one configuration, the network entity 1502 further includes means for transmitting at least one additional SSB on at least one different synchronization raster that does not indicate support for the physical layer security, where the SSB on the synchronization raster indicating that the network supports the physical layer security has a different configuration than the at least one additional SSB on the at least one different synchronization raster that does not indicate the support for the physical layer security. In one configuration, the network entity 1502 further includes means for transmitting at least one additional SSB on at least one different synchronization raster that does not indicate support for the physical layer security, where the SSB on the synchronization raster indicating that the network supports the physical layer security include a higher number of DM-RS resources than the at least one additional SSB on the at least one different synchronization raster that does not indicate the support for the physical layer security. In one configuration, the synchronization raster indicates a security level of the physical layer security supported by the network. In one configuration, the synchronization raster indicating that the network supports the physical layer security has a frequency located between other synchronization rasters that are not associated with support for the physical layer security. In one configuration, the network entity 1502 further includes means for transmitting an indication to the UE to extract the secret key using the SSB. The means may be the physical security secret key component 199 of the network entity 1502 configured to perform the functions recited by the means. As described supra, the network entity 1502 may include the TX processor 316, the RX processor 370, and the controller/processor 375. As such, in one configuration, the means may be the TX processor 316, the RX processor 370, and/or the controller/processor 375 configured to perform the functions recited by the means.

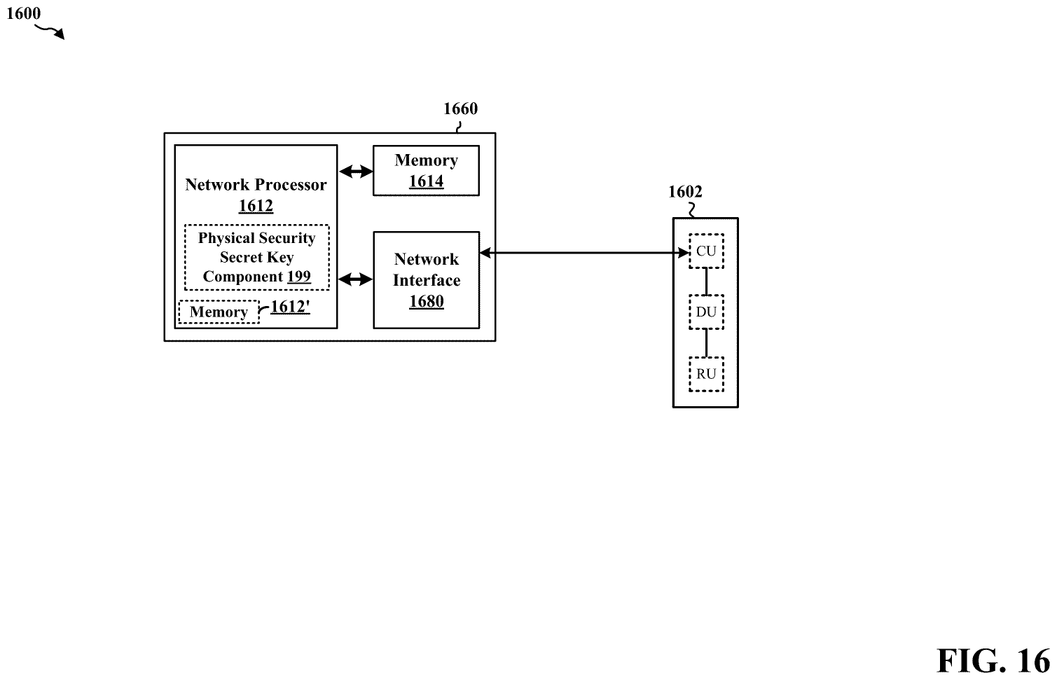

FIG. 16 is a diagram 1600 illustrating an example of a hardware implementation for a network entity 1660. In one example, the network entity 1660 may be within the core network 120. The network entity 1660 may include a network processor 1612. The network processor 1612 may include on-chip memory 1612′. In some aspects, the network entity 1660 may further include additional memory modules 1614. The network entity 1660 communicates via the network interface 1680 directly (e.g., backhaul link) or indirectly (e.g., through a RIC) with the CU 1602. The on-chip memory 1612′ and the additional memory modules 1614 may each be considered a computer-readable medium/memory. Each computer-readable medium/memory may be non-transitory. The processor 1612 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the physical security secret key component 199 is configured to transmit an SSB that indicates a network supports physical layer security, extract a secret key based on a reference signal received from a UE, and transmit or receive communication using the secret key. The physical security secret key component 199 may be within the processor 1612. The physical security secret key component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1660 may include a variety of components configured for various functions. In one configuration, the network entity 1660 includes means for transmitting an SSB that indicates a network supports physical layer security, means for extracting a secret key based on a reference signal received from a UE, and means for transmitting or receiving communication using the secret key. In one configuration, the SSB includes a sequence indicating that the network supports the physical layer security. In one configuration, the SSB includes an allocation of one or more sequences to a set of resource elements, the allocation indicating that the network supports the physical layer security. In one configuration, the SSB includes a PBCH DM-RS pattern indicating that the network supports the physical layer security. In one configuration, a synchronization raster of the SSB indicates that the network supports the physical layer security. In one configuration, the network entity 1660 further includes means for transmitting at least one additional SSB on at least one different synchronization raster that does not indicate support for the physical layer security, where an SSB structure is common to the SSB on the synchronization raster indicating that the network supports the physical layer security and the at least one additional SSB on the at least one different synchronization raster that does not indicate the support for the physical layer security. In one configuration, the network entity 1660 further includes means for transmitting at least one additional SSB on at least one different synchronization raster that does not indicate support for the physical layer security, where the SSB on the synchronization raster indicating that the network supports the physical layer security has a different SSB structure than the at least one additional SSB on the at least one different synchronization raster that does not indicate the support for the physical layer security. In one configuration, the network entity 1660 further includes means for transmitting at least one additional SSB on at least one different synchronization raster that does not indicate support for the physical layer security, where the SSB on the synchronization raster indicating that the network supports the physical layer security has a different configuration than the at least one additional SSB on the at least one different synchronization raster that does not indicate the support for the physical layer security. In one configuration, the network entity 1660 further includes means for transmitting at least one additional SSB on at least one different synchronization raster that does not indicate support for the physical layer security, where the SSB on the synchronization raster indicating that the network supports the physical layer security include a higher number of DM-RS resources than the at least one additional SSB on the at least one different synchronization raster that does not indicate the support for the physical layer security. In one configuration, the synchronization raster indicates a security level of the physical layer security supported by the network. In one configuration, the synchronization raster indicating that the network supports the physical layer security has a frequency located between other synchronization rasters that are not associated with support for the physical layer security. In one configuration, the network entity 1660 further includes means for transmitting an indication to the UE to extract the secret key using the SSB. The means may be the physical security secret key component 199 of the network entity 1660 configured to perform the functions recited by the means.

In some aspects of the current disclosure, a user equipment be configured to receive, from a base station, an SSB that indicates a network supports physical layer security, extract a secret key for the physical layer security with the network in response to the SSB indicating that the network supports the physical layer security, and transmit or receive communication with the base station using the secret key, and a network node may be configured to transmit an SSB that indicates a network supports physical layer security, extract a secret key based on a reference signal received from a UE, and transmit or receive communication using the secret key. That is, the network node may transmit an SSB indicating that the network may support physical layer security, and the UE may extract the secret key for the physical layer security based on the received SSB indicating that the network may support the physical layer security. The base station may indicate a level of the physical layer security using the SSB, and the UE may determine the level of the physical layer security based on the received SSB. In one aspect, the indication that the network may support the physical layer security may be included in the SSB. In another aspect, a synchronization raster of the SSB may indicate that the network supports the physical layer security.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including receiving, from a network node, an SSB that indicates a network supports physical layer security, extracting a secret key for the physical layer security with the network in response to the SSB indicating that the network supports the physical layer security, and transmitting or receiving communication with the network node using the secret key.

Aspect 2 is the method of aspect 1, where the SSB includes a sequence indicating that the network supports the physical layer security.

Aspect 3 is the method of any of aspects 1 and 2, where the SSB includes an allocation of one or more sequences to a set of resource elements, the allocation indicating that the network supports the physical layer security.

Aspect 4 is the method of any of aspects 1 to 3, where the SSB includes a PBCH DM-RS pattern indicating the network supports the physical layer security.

Aspect 5 is the method of any of aspects 1 to 4, where a synchronization raster of the SSB indicates that the network supports the physical layer security.

Aspect 6 is the method of aspect 5, where an SSB structure is common to the SSB on the synchronization raster indicating that the network supports the physical layer security and an additional SSB on an additional synchronization raster that does not indicate support for the physical layer security.

Aspect 7 is the method of any of aspects 5 and 6, where the SSB on the synchronization raster indicating that the network supports the physical layer security has a different SSB structure than additional SSB on an additional synchronization raster that does not indicate support for the physical layer security.

Aspect 8 is the method of any of aspects 5 to 7, where the SSB on the synchronization raster indicating that the network supports the physical layer security has a different configuration than additional SSB on an additional synchronization raster that does not indicate support for the physical layer security.

Aspect 9 is the method of aspect 8, where the different configuration includes a different periodicity.

Aspect 10 is the method of any of aspects 5 to 9, where the SSB on the synchronization raster indicating that the network supports the physical layer security include a higher number of DM-RS resources than additional SSB on an additional synchronization raster that does not indicate support for the physical layer security.

Aspect 11 is the method of any of aspects 5 to 10, where the synchronization raster indicates a security level.

Aspect 12 is the method of aspect 11, where different synchronization rasters are associated with different levels of the physical layer security supported by the network.

Aspect 13 is the method of any of aspects 11 and 12, further including determining a level of the physical layer security supported by the network based on the synchronization raster on which the SSB is received.

Aspect 14 is the method of any of aspects 5 to 13, where the synchronization raster indicating that the network supports the physical layer security has a frequency located between other synchronization rasters that do not indicate support for the physical layer security.

Aspect 15 is the method of any of aspects 5 to 14, further including receiving an indication from the network node to extract the secret key using the SSB.

Aspect 16 is the method of any of aspects 5 to 15, where a reference signal for extracting the secret key has a QCL relationship with one of more beams of the SSB on the synchronization raster.

Aspect 17 is an apparatus for wireless communication including at least one processor coupled to a memory and configured to implement any of aspects 1 to 16, further including a transceiver coupled to the at least one processor.

Aspect 18 is an apparatus for wireless communication including means for implementing any of aspects 1 to 16.

Aspect 19 is a non-transitory computer-readable medium storing computer executable code, where the code when executed by a processor causes the processor to implement any of aspects 1 to 16.

Aspect 20 is a method of wireless communication at a network node, including transmitting an SSB that indicates a network supports physical layer security, extracting a secret key based on a reference signal received from a UE, and transmitting or receiving communication using the secret key.

Aspect 21 is the method of aspect 20, where the SSB includes a sequence indicating that the network supports the physical layer security.

Aspect 22 is the method of any of aspects 20 and 21, where the SSB includes an allocation of one or more sequences to a set of resource elements, the allocation indicating that the network supports the physical layer security.

Aspect 23 is the method of any of aspects 20 to 22, where the SSB includes a PBCH DM-RS pattern indicating that the network supports the physical layer security.

Aspect 24 is the method of any of aspects 20 to 23, where a synchronization raster of the SSB indicates that the network supports the physical layer security.

Aspect 25 is the method of aspect 24, further including transmitting at least one additional SSB on at least one different synchronization raster that does not indicate support for the physical layer security, where an SSB structure is common to the SSB on the synchronization raster indicating that the network supports the physical layer security and the at least one additional SSB on the at least one different synchronization raster that does not indicate the support for the physical layer security.

Aspect 26 is the method of any of aspects 24 and 25, further including transmitting at least one additional SSB on at least one different synchronization raster that does not indicate support for the physical layer security, where the SSB on the synchronization raster indicating that the network supports the physical layer security has a different SSB structure than the at least one additional SSB on the at least one different synchronization raster that does not indicate the support for the physical layer security.

Aspect 27 is the method of any of aspects 24 to 26, further including transmitting at least one additional SSB on at least one different synchronization raster that does not indicate support for the physical layer security, where the SSB on the synchronization raster indicating that the network supports the physical layer security has a different configuration than the at least one additional SSB on the at least one different synchronization raster that does not indicate the support for the physical layer security.

Aspect 28 is the method of any of aspects 24 to 27, further including transmitting at least one additional SSB on at least one different synchronization raster that does not indicate support for the physical layer security, where the SSB on the synchronization raster indicating that the network supports the physical layer security include a higher number of DM-RS resources than the at least one additional SSB on the at least one different synchronization raster that does not indicate the support for the physical layer security.

Aspect 29 is the method of any of aspects 24 to 28, where the synchronization raster indicates a security level of the physical layer security supported by the network.

Aspect 30 is the method of any of aspects 24 to 29, where the synchronization raster indicating that the network supports the physical layer security has a frequency located between other synchronization rasters that are not associated with support for the physical layer security.

Aspect 31 is the method of any of aspects 24 to 30, further including transmitting an indication to the UE to extract the secret key using the SSB.

Aspect 32 is an apparatus for wireless communication including at least one processor coupled to a memory and configured to implement any of aspects 20 to 31, further including a transceiver coupled to the at least one processor.

Aspect 33 is an apparatus for wireless communication including means for implementing any of aspects 20 to 31.

Aspect 34 is a non-transitory computer-readable medium storing computer executable code, where the code when executed by a processor causes the processor to implement any of aspects 20 to 31.

What is claimed is:

1. An apparatus for wireless communication at a user equipment (UE), comprising:
a memory; and
at least one processor coupled to the memory and, based at least in part on information stored in the memory, the at least one processor is configured to:
receive, from a network node, a synchronization signal block (SSB) that indicates a network supports physical layer security;
extract a secret key for the physical layer security with the network in response to the SSB indicating that the network supports the physical layer security; and
transmit or receive communication with the network node using the secret key.

2. The apparatus of claim 1, wherein the SSB includes a sequence indicating that the network supports the physical layer security.

3. The apparatus of claim 1, wherein the SSB includes an allocation of one or more sequences to a set of resource elements, the allocation indicating that the network supports the physical layer security.

4. The apparatus of claim 1, wherein the SSB includes a physical broadcast channel (PBCH) demodulation reference signal (DM-RS) pattern indicating the network supports the physical layer security.

5. The apparatus of claim 1, wherein a synchronization raster of the SSB indicates that the network supports the physical layer security.

6. The apparatus of claim 5, wherein an SSB structure is common to the SSB on the synchronization raster indicating that the network supports the physical layer security and an additional SSB on an additional synchronization raster that does not indicate support for the physical layer security.

7. The apparatus of claim 5, wherein the SSB on the synchronization raster indicating that the network supports the physical layer security has a different SSB structure than additional SSB on an additional synchronization raster that does not indicate support for the physical layer security.

8. The apparatus of claim 5, wherein the SSB on the synchronization raster indicating that the network supports the physical layer security has a different configuration than additional SSB on an additional synchronization raster that does not indicate support for the physical layer security.

9. The apparatus of claim 8, wherein the different configuration includes a different periodicity.

10. The apparatus of claim 5, wherein the SSB on the synchronization raster indicating that the network supports the physical layer security include a higher number of demodulation reference signal (DM-RS) resources than additional SSB on an additional synchronization raster that does not indicate support for the physical layer security.

11. The apparatus of claim 5, wherein the synchronization raster indicates a security level.

12. The apparatus of claim 11, wherein different synchronization rasters are associated with different levels of the physical layer security supported by the network.

13. The apparatus of claim 11, wherein the at least one processor is further configured to:
determine a level of the physical layer security supported by the network based on the synchronization raster on which the SSB is received.

14. The apparatus of claim 5, wherein the synchronization raster indicating that the network supports the physical layer security has a frequency located between other synchronization rasters that do not indicate support for the physical layer security.

15. The apparatus of claim 5, wherein the at least one processor is further configured to:
receive an indication from the network node to extract the secret key using the SSB.

16. The apparatus of claim 5, wherein a reference signal for extracting the secret key has a quasi co-location (QCL) relationship with one of more beams of the SSB on the synchronization raster.

17. An apparatus for wireless communication at a network node, comprising:
a memory; and
at least one processor coupled to the memory and, based at least in part on information stored in the memory, the at least one processor is configured to:
transmit a synchronization signal block (SSB) that indicates a network supports physical layer security;
extract a secret key based on a reference signal received from a user equipment (UE); and
transmit or receive communication using the secret key.

18. The apparatus of claim 17, wherein the SSB includes a sequence indicating that the network supports the physical layer security.

19. The apparatus of claim 17, wherein the SSB includes an allocation of one or more sequences to a set of resource elements, the allocation indicating that the network supports the physical layer security.

20. The apparatus of claim 17, wherein the SSB includes a physical broadcast channel (PBCH) demodulation reference signal (DM-RS) pattern indicating that the network supports the physical layer security.

21. The apparatus of claim 17, wherein a synchronization raster of the SSB indicates that the network supports the physical layer security.

22. The apparatus of claim 21, wherein the at least one processor is further configured to:
transmit at least one additional SSB on at least one different synchronization raster that does not indicate support for the physical layer security, wherein an SSB structure is common to the SSB on the synchronization raster indicating that the network supports the physical layer security and the at least one additional SSB on the at least one different synchronization raster that does not indicate the support for the physical layer security.

23. The apparatus of claim 21, wherein the at least one processor is further configured to:
transmit at least one additional SSB on at least one different synchronization raster that does not indicate support for the physical layer security, wherein the SSB on the synchronization raster indicating that the network supports the physical layer security has a different SSB structure than the at least one additional SSB on the at least one different synchronization raster that does not indicate the support for the physical layer security.

24. The apparatus of claim 21, wherein the at least one processor is further configured to:
transmit at least one additional SSB on at least one different synchronization raster that does not indicate support for the physical layer security, wherein the SSB on the synchronization raster indicating that the network supports the physical layer security has a different configuration than the at least one additional SSB on the at least one different synchronization raster that does not indicate the support for the physical layer security.

25. The apparatus of claim 21, wherein the at least one processor is further configured to:
transmit at least one additional SSB on at least one different synchronization raster that does not indicate support for the physical layer security, wherein the SSB on the synchronization raster indicating that the network supports the physical layer security include a higher number of demodulation reference signal (DM-RS) resources than the at least one additional SSB on the at least one different synchronization raster that does not indicate the support for the physical layer security.

26. The apparatus of claim 21, wherein the synchronization raster indicates a security level of the physical layer security supported by the network.

27. The apparatus of claim 21, wherein the synchronization raster indicating that the network supports the physical layer security has a frequency located between other synchronization rasters that are not associated with support for the physical layer security.

28. The apparatus of claim 21, wherein the at least one processor is further configured to:
transmit an indication to the UE to extract the secret key using the SSB.

29. A method of wireless communication at a user equipment (UE), comprising:
receiving, from a network node, a synchronization signal block (SSB) that indicates a network supports physical layer security;
extracting a secret key for the physical layer security with the network in response to the SSB indicating that the network supports the physical layer security; and
transmitting or receiving communication with the network node using the secret key.

30. A method of wireless communication at a network node, comprising:
transmitting a synchronization signal block (SSB) that indicates a network supports physical layer security;
extracting a secret key based on a reference signal received from a user equipment (UE); and
transmitting or receiving communication using the secret key.
